(19) United States
(12) Patent Application Publication
(10) Pub. No.: US 2004/0090114 A1
(43) Pub. Date: May 13, 2004

(54) ABS ON-OFF code diagnostics communication system

(76) Inventors: Joseph M. Macnamara, Ashland, OH (US); Paul J. Waszkowski, Hinckley, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/292,345

(22) Filed: Nov. 12, 2002

(51) Int. Cl. B60T 8/34

(52) U.S. Cl. 303/118.1; 303/122.02; 303/123

(57) ABSTRACT

A trailer ABS diagnostics display system utilizes an output device to communicate specific ABS diagnostics information to a user located within the tractor cab in the form of ON-OFF code data. The system preferably includes wheel velocity sensors, at least one brake pressure modulator, an output device, a user interface which generates a user request signal, and an electronic control unit that is connected to the wheel velocity sensors, the brake pressure modulator, the output device, and the user interface. The electronic control unit generates the ON-OFF code data which is indicative of a diagnostic condition in response to the user request signal. The ON-OFF code data is transmitted to the output device for communication to the user located with the tractor cab.

### FIELD OF THE INVENTION

The invention relates in general to a system that communicates trailer antilock brake system diagnostics information to a user. More specifically, the diagnostics information is generated in the form of ON-OFF code data that is indicative of a diagnostic condition. The ON-OFF code data is communicated, either audibly or visually, to a user located within a tractor cab of the vehicle.

### BACKGROUND OF THE INVENTION

Federal Motor Vehicle Safety Standard 121 requires newly manufactured trailers that are hitched to a heavy duty tractor-trailer combination to be equipped with an antilock brake system (ABS). During braking, friction between the tread of the tire and the road surface is at its maximum just before the wheel locks up. The stopping distance of a trailer with locked up wheels may greatly exceed that of a trailer whose wheels are kept rotating at a point just before they lock up. If the wheels are locked while the tractor-trailer combination is still moving, there is an increased instability in the vehicle, which could lead to loss of control or tipping of the vehicle. ABS limits the braking pressure if a wheel starts to lock up, keeping the wheel turning in an emergency stop. As a result, trailer stopping distance is reduced and the stability of the tractor-trailer combination during breaking is improved.

These systems normally perform quite well and are very reliable. However, due to environmental and physical stresses to which the components of the ABS are subjected, such systems occasionally malfunction. Common malfunctions include a shorted or open sensor or modulator due to a broken wire or a connector being vibrated loose. Accordingly, many trailer ABS offer a simple warning device on the trailer that is switched ON when an ABS malfunction is detected. In addition, a trailer ABS warning light may be provided on the instrument panel of the tractor cab to notify the user whether the ABS is functional. In general, such ABS warning indications are now required.

Some malfunctions, however, are intermittent. Because the trailer ABS warning lights are usually activated only during the actual malfunction, the warning device may not be activated during maintenance periods. Therefore, there is no indication or record of intermittent malfunctions, so the defect causing an intermittent malfunction may not be noted or corrected during maintenance periods.

Many manufacturers incorporate an ABS diagnostics with memory capability into their ABS units. For example, U.S. Pat. Nos. 4,837,552 and 6,114,952 disclose ABS units having self diagnostics and storage capabilities. The disclosures of U.S. Pat. Nos. 4,837,552 and 6,114,952 are incorporated herein by reference. In the unit disclosed in U.S. Pat. No. 4,837,552, a series of light emitting diodes (LEDs) are provided on the exterior of a trailer ABS electronic control unit (ECU) housing. Each of the LEDs are activated in response to a predetermined discrete fault in the system. The faults are sensed by the trailer ABS ECU, indicated on the LEDs, and stored in a non-volatile memory when the system is powered down.

The trailer ABS ECU is typically installed in an obscure location on the trailer frame or air reservoir, which can make it difficult to observe the diagnostics LEDs. Therefore, the unit disclosed in U.S. Pat. No. 6,114,952 provides the added capability to interface with an off-board diagnostic tool such as a personal computer (PC). When the unit is used by itself, it is capable of locating individual ABS faults using a series of LEDs or lights that indicate the faulty device or its wiring and the location on the trailer.

When the ABS unit is used in conjunction with an off board diagnostics tool, such as a PC having ABS diagnostics software, the unit becomes a communications arbitrator between the tractor-trailer combination's numerous onboard controllers and the PC. One compatible software is ACom which is a proprietary software developed by Bendix Commercial Vehicle Systems, LLC, of Elyria, Ohio. Unfortunately, if the user must perform trailer ABS diagnostics while he is traveling on the highway, such diagnostic tools are not always readily available.

Diagnostics methods have been developed that encode and then communicate the operational status of the components of an ABS to the user without an off board diagnostics tool. One such method is BLINK CODE diagnostics. BLINK CODE diagnostics offer several modes of operation, including active-fault ABS diagnostics, fault history ABS diagnostics, clear active faults, ABS configuration check, and trailer odometer display. This method is a proprietary method of Bendix Commercial Vehicle Systems. To activate the system, the user requests the desired BLINK CODE diagnostics mode by pumping the brake pedal in the tractor cab to cycle the brake light power ON and OFF for a predetermined number of cycles, or by cycling a blink code switch. For example, three cycles requests active-fault retrieval, four cycles requests fault history retrieval, five cycles requests clearing active faults, six cycles requests ABS configuration check, and seven cycles requests trailer ABS diagnostics display. In response to the request, the trailer ABS ECU encodes the diagnostics information into BLINK CODE data and then communicates the BLINK CODE data to the user by flashing an exterior trailer ABS warning lamp provided on the trailer.

The exterior trailer ABS warning lamp is a low wattage automotive bulb with an amber lens, and it is located at the back of the trailer. It often is difficult to observe the illumination of this type of lamp, because, for example, the lamp may be obscured due to bright daylight, poor visibility weather, road film, or accumulated ice and snow. When the exterior trailer ABS warning lamp is not visible, the user must exit the tractor cab and walk to the exterior of the trailer to view the exterior trailer ABS warning lamp. Exiting the tractor cab in order to obtain BLINK CODE diagnostics is inconvenient for the user.

### SUMMARY OF THE INVENTION

The present invention provides a trailer ABS diagnostics display system that utilizes an output device to communicate ABS diagnostics information to a user in the form of ON-OFF code data while the user remains seated within a vehicle, such as a tractor cab.

In a preferred embodiment, the ABS diagnostics display system includes wheel velocity sensors; at least one brake pressure modulator; an output device; a user interface that generates a user request signal; and an electronic control unit (ECU) that is connected to the wheel velocity sensors, the brake pressure modulator, the output device, and the user interface. The electronic control unit generates encoded diagnostic data in the form of an ON-OFF code data (for example, BLINK CODE data) in response to the user request signal. The ON-OFF code data is then transmitted to the output device to communicate specific diagnostic information, such as that relating to a specific malfunction, to the user while the user remains within the tractor cab.

In a preferred embodiment, the output device is a warning lamp located within the tractor cab that is turned ON and OFF in response to the ON-OFF code data. The warning lamp can either be a lamp dedicated to displaying the ON-OFF code data or may be an existing lamp already provided on the tractor cab that is utilized for dual purposes. For example, many ABS already have a cab-mounted trailer ABS warning light to indicate the general functional status of the ABS. This trailer ABS warning light can be coupled to also receive the ON-OFF code data that is indicative of specific diagnostic information.

The use of a dedicated warning light may require that changes be made in the wiring of existing vehicles. For example, it may be necessary to run a separate wire from the trailer ABS ECU to the dedicated warning light in order to supply the ON-OFF data to the dedicated warning light. If an existing lamp is utilized, it still may be necessary to find a way of supplying the ON-OFF code data to the existing lamp. Many conventional trailer ABS warning lights in the tractor cab are coupled to a tractor ECU and not the trailer ABS ECU, so modifications could be required to provide a signal to the existing lamp in the cab from the trailer ABS ECU.

Another preferred embodiment transmits the ON-OFF code data between the trailer and the tractor cab using a power line carrier communications protocol. In this embodiment, the trailer and tractor are both equipped with transceivers that are coupled to a power supply circuit of the vehicle. The transceiver in the tractor cab is coupled to the tractor ECU which is coupled to the warning lamp, while the transceiver in the trailer is coupled to the trailer ABS ECU. Accordingly, the ON-OFF data can be transmitted from the trailer ABS ECU through the power supply circuit and the tractor ECU to the warning lamp. The use of power line carrier communications eliminates the necessity of providing additional wiring between the electronic control unit and the output device, while allowing existing lamps to be utilized.

However, other types of output devices that produce visual or audible signals recognizable to a user located within the tractor cab may readily be utilized. For example, in a further embodiment, an antilock brake system modulator valve is operated to produce an ON-OFF audible signal.

The user interface is preferably a vehicle brake pedal which is connected to a brake power switch. Tapping the brake pedal in a desired sequence causes the generation of the user request signal.

Other advantages and features of the invention will become apparent from the following detailed description of the preferred embodiments and the accompanying drawings.

### BRIEF DESCRIPTION OF THE DRAWINGS

The invention will now be described with reference to certain preferred embodiments thereof and the accompanying drawings, wherein:

FIG. 1 is a basic schematic diagram of a conventional trailer ABS;

FIG. 2 is a basic schematic block diagram of a ABS diagnostics communication system in accordance with the present invention; and

FIG. 3 is a schematic block diagram of an ABS diagnostics communication system in accordance with the present invention that utilizes power line carrier communications.

### DETAILED DESCRIPTION OF THE PREFERRED EMBODIMENTS

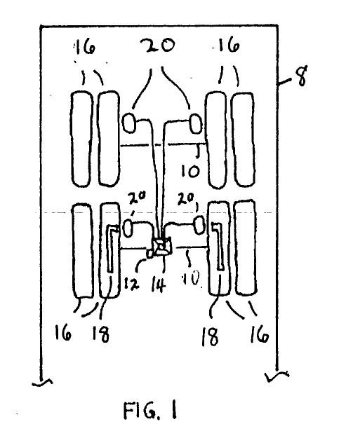

FIG. 1 is a schematic diagram of a trailer 8 having two axles 10 on which ABS is installed. The components of the ABS include a trailer ABS electronic control unit (ECU) 12, an air brake pressure modulator 14, two or more wheel mounted velocity sensors 18 that monitor the velocity of the trailer wheels 16, and air brake chambers 20. The trailer ABS ECU 12 is connected to the velocity sensors 18 through ports (not shown) on the housing of the trailer ABS ECU 12. The velocity sensors 18 provide a pulsed output which is transmitted to the trailer ABS ECU 12, wherein the frequency of the pulses are proportional to wheel velocity. The trailer ABS ECU 12 processes the signals received from the velocity sensors 18 and generates output signals that control one or more air brake pressure modulators 14.

ABS control of trailer braking is activated when skidding conditions are detected by the trailer ABS ECU 12 in response to the signals generated by the velocity sensors 18. The trailer ABS ECU 12 utilizes one or more air brake pressure modulators 14 to modulate the braking force that is applied to the wheels 16 by the air brake chambers 20, for example, by decreasing and thereafter increasing braking pressure. Modulation of the braking force is continued until skidding conditions subside.

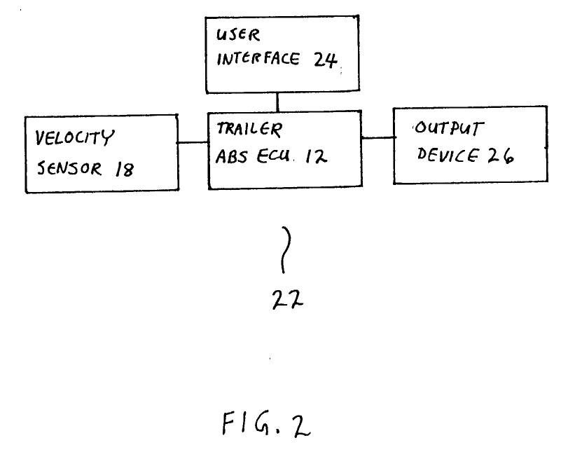

FIG. 2 is a basic block diagram of a trailer ABS diagnostics display system 22 in accordance with the present invention. The trailer ABS diagnostics display system 22 includes a trailer ABS ECU 12, at least one wheel 16 mounted velocity sensor 18, a user interface 24, and an output device 26 located in the tractor cab. The velocity sensor 18 is preferably a wheel mounted signal generating device which is a component of a trailer ABS. However, any other suitable velocity sensor 18 may be utilized such as a wheel axle revolution rate sensor. The user interface 24 is preferably a brake pedal in the tractor cab that is connected to a brake light power switch. Alternatively, the user interface 24 may be either a user activated switch, computer keyboard interface or other device that is mounted in the tractor cab. The output device 26 is capable of communicating ABS diagnostics information in the form of ON-OFF code data to the user while the user is seated within the tractor cab.

The output device 26 may be either a visible signal or audible signal device. For example, in a preferred embodiment, the output device 26 is a conventional tractor cab mounted trailer ABS warning lamp; however, the output device 26 can also be an audible signal device such as a horn, bell or buzzer. Still further, an ABS modulator exhaust valve can be used to produce an audible signal. In such a case, the trailer ABS ECU 12 activates an exhaust valve of the air brake pressure modulator 14 to create a quick audible pulse of air known as “chuffing.” The audible pulse is made louder when the user places his foot on the brake pedal to increase air pressure.

In a preferred embodiment of the invention, BLINK CODE diagnostics are utilized to communicate encoded ABS diagnostics data to the user by activating and deactivating the output device 26. BLINK CODE diagnostics operate according to the following sequence. With ignition power on, the trailer ABS ECU 12 continuously monitors the number of brake light power cycles, to determine whether or not to activate a BLINK CODE diagnostics mode. A BLINK CODE diagnostics mode may only be activated immediately following tractor ignition power-up, when the trailer is parked. If wheel velocities that are indicative of trailer movement are detected during BLINK CODE diagnostics mode, the trailer ABS ECU 12 immediately exits BLINK CODE diagnostics and returns to normal operating mode. To prevent unintentional activation of BLINK CODE diagnostics mode, the brake light power cycle counter is disabled when ignition power is continuously ON for more than 15.0 seconds without entering BLINK CODE mode. The maximum constant brake light power ON duration before disabling the brake light power cycle counter is 5.0 seconds. Other preselected time durations may be utilized; the precise times specified herein are merely exemplary.

The user requests activation of a desired BLINK CODE diagnostics mode by cycling the brake light power ON and OFF. In response to the request, the trailer ABS ECU 12 initiates the appropriate BLINK CODE diagnostics mode. After activation of the requested BLINK CODE diagnostics mode, there is a 5.0 second delay before output of the diagnostics commences. The trailer ABS ECU 12 utilizes available diagnostic data indicative of the operating condition of the ABS to generate ON-OFF code data. The ON-OFF code data is then communicated to the output device 26. Once the output device 26 begins activation and deactivation based on the ON-OFF code data, the trailer ABS ECU 12 does not respond to any additional brake light power cycling until all BLINK CODED messages have been displayed and the unit has returned to normal operating mode.

In accordance with a preferred embodiment of the invention, the trailer ABS ECU 12 communicates the ON-OFF code data directly to the output device 26. Providing a direct connection, however, may require additional signal lines to the wiring system of the vehicle between the trailer and tractor cab. It may be desirable to be able to communicate the ON-OFF code data to the output device 26 using available communication paths. For example, a power line carrier communication (PLCC) protocol is used to communicate the ON-OFF code data using available communication paths.

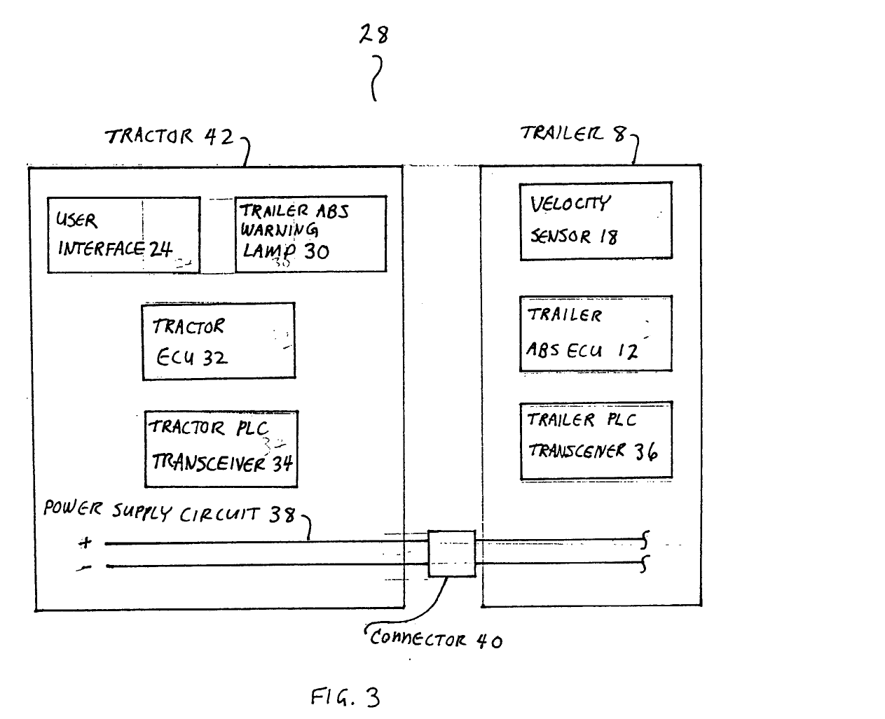

FIG. 3 is a schematic block diagram illustrating a further embodiment of the invention that utilizes PLCC to communicate ON-OFF code data from the trailer ABS ECU 12 to the output device 26. In the embodiment illustrated in FIG. 3, the output device takes the form of an existing ABS warning lamp 30 that is coupled to a tractor ECU 32 along with the user interface 24. The tractor ECU 32 is coupled to a tractor power line communication (PLC) transceiver 34 that communicates with a vehicle power supply circuit 38. The vehicle power supply 38 extends from the tractor 42 to the trailer 8 via a connector 40. The trailer 8 is provided with a trailer PLC transceiver 36 that communicates with the vehicle power supply line 38 on the trailer side. Accordingly, communication between the tractor 42 and trailer 8 can be achieved, utilizing the PLCC protocol over the existing power supply circuit 38, the tractor PLC transceiver 34 and the trailer PLC transceiver 36, to provide two way communication between the tractor ECU 32 and the trailer ABS ECU 12. Accordingly, the need for an additional wiring between the trailer and tractor is eliminated and an existing lamp can be used as the output device. The Society of Automotive Engineers (SAE) J2497, Rev. Draft, Apr. 26, 2000, Society of Automotive Engineers, Inc., the contents of which are incorporated herein by reference, provides a recommended practice for communicating between a vehicle trailer and tractor using a PLCC protocol.

The invention has been described with reference to certain preferred embodiments thereof. It will be understood, however, that modification and variations are possible within the scope of the appended claims. For example, although the preferred embodiment utilizes an existing ABS warning lamp to display the ON-OFF code data, any existing lamp on the tractor cab or existing accessory device—such as a horn—may be utilized. Alternatively, a dedicated device may be employed instead of an existing device. Still further, it should be understood that any output device that is capable of communication of the ON-OFF data to a user located within the tractor cab is within the scope of the invention. Thus, the output device may be located on the tractor cab or on the trailer.

What is claimed is:

1. An antilock brake system diagnostics communication system for a vehicle having an antilock brake system, comprising:
a user interface capable of generating a user request signal;
an electronic control unit capable of receiving the user request signal and generating ON-OFF code data indicative of a diagnostic condition of the antilock brake system in response to the user request signal; and
an output device capable of communicating the ON-OFF code data from the electronic control unit to a user located within the vehicle.

2. The system of claim 1, wherein the vehicle comprises a tractor-trailer combination having a tractor cab in which the user is located and a trailer to be towed by the tractor.

3. The system of claim 2, wherein the output device comprises a visual indicator mounted in the tractor cab.

4. The system of claim 1, wherein the output device comprises an auditory indicator.

5. The system of claim 1, wherein the output device comprises a visual indicator mounted in the vehicle.

6. The system of claim 5, wherein the visual indicator is a warning lamp.

7. The system of claim 1, wherein the user interface is a brake pedal.

8. An antilock brake system diagnostics communication system for a vehicle having an antilock brake system, comprising:
means for requesting communication of antilock brake system diagnostics;
means for generating ON-OFF code data indicative of a diagnostic condition of the antilock brake system; and
means for communicating the ON-OFF code data to a user located within the vehicle.

9. The antilock brake system diagnostics communication system of claim 8, wherein the vehicle comprises a tractor-trailer combination having a tractor cab in which the user is located and a trailer to be towed by the tractor.

10. The antilock brake system diagnostics communication system for a vehicle of claim 9, wherein the means for communicating includes a visual indicator mounted in the tractor cab.

11. The antilock brake system diagnostics communication system of claim 9, wherein the means for communicating includes means for implementing a power line carrier communication protocol between the tractor cab and the trailer.

12. The antilock brake system diagnostics communication system for a vehicle of claim 8, wherein the means for communicating includes an auditory device.

13. The antilock brake system diagnostics communication system for a vehicle of claim 8, wherein the means for communicating includes an antilock brake system modulator valve and means for generating an audible signal with the antilock brake system modulator valve.

14. A method for communicating antilock brake system diagnostics for a vehicle having an antilock brake system, comprising:
requesting communication of antilock brake system diagnostics;
generating ON-OFF code data indicative of a diagnostic condition of the antilock brake system; and
communicating the ON-OFF code data to a user in the vehicle.

15. The method for communicating antilock brake system diagnostics of claim 14, wherein the ON-OFF code data is communicated to the user with a visual indication.

16. The method for communicating antilock brake system diagnostics of claim 14, wherein the ON-OFF code data is communicated to the user with an auditory device.

17. The method for communicating antilock brake system diagnostics of claim 14, wherein the ON-OFF code data is communicated to the user with an antilock brake system modulator valve that is operated to produce an audible signal.

18. The method for communicating antilock brake system diagnostics of claim 14, wherein the vehicle comprises a tractor-trailer combination having a tractor cab in which the user is located and a trailer to be towed by the tractor.

19. The method for communicating antilock brake system diagnostics as claimed in claim 18, wherein the ON-OFF code data is communicated between the tractor cab and trailer via a power line carrier communication protocol.

20. An antilock brake system diagnostics communication system for a vehicle comprising a tractor cab coupled to a trailer, said system comprising:
a plurality of wheel velocity sensors mounted on the trailer;
at least one brake pressure modulator mounted on the trailer;
an output device capable of conveying information to a user located within the tractor cab;
a user interface located in the tractor cab that generates a user request signal; and
an electronic control unit that is coupled to the wheel velocity sensors, the brake pressure modulator, the output device, and the user interface;
wherein in response to the user request signal, the electronic control unit performs antilock brake system diagnostics and generates ON-OFF code data indicative of a diagnostic condition of the antilock brake system; and
wherein the electronic control unit transmits the ON-OFF code data to the output device.

21. The antilock brake system diagnostics communication system for a vehicle of claim 20, wherein the output device includes a warning lamp.

22. The antilock brake system diagnostics communication system for a vehicle of claim 20, wherein the electronic control unit comprises a trailer-mounted antilock brake electronic control unit, and wherein the trailer-mounted antilock brake electronic control unit is coupled to the output device and the user interface via a power line carrier communication network.

23. The antilock brake system diagnostics communication system for a vehicle of claim 22, wherein the power line carrier communication network includes:
a trailer-mounted transceiver coupled to the trailer mounted antilock brake electronic control unit and a power supply circuit; and
a tractor-mounted transceiver coupled to the power supply circuit and a tractor electronic control unit;
wherein the tractor electronic control unit is coupled to the user interface and the output device.

24. The antilock brake system diagnostics communication system for a vehicle of claim 20, wherein the output device comprises an auditory device.

25. The antilock brake system diagnostics communication system for a vehicle of claim 20, wherein the output device comprises an antilock brake system modulator valve that is controlled by the electronic control unit to generate an audible signal.

26. The antilock brake system diagnostics communication system for a vehicle of claim 20, wherein the user interface comprises a vehicle brake pedal.
